(19) United States
(12) Patent Application Publication
(10) Pub. No.: US 2016/0019877 A1
(43) Pub. Date: Jan. 21, 2016

(54) SYSTEM FOR NETWORKING AUDIO EFFECTS PROCESSORS, ENABLING BIDIRECTIONAL COMMUNICATION AND STORAGE/RECALL OF DATA

(71) Applicant: Jesse Martin Remignanti, Newbury, MA (US)

(72) Inventor: Jesse Martin Remignanti, Newbury, MA (US)

(21) Appl. No.: 14/457,223

(22) Filed: Aug. 12, 2014

Related U.S. Application Data
(60) Provisional application No. 62/027,017, filed on Jul. 21, 2014.

(51) Int. Cl. G10H 1/00

(52) U.S. Cl. CPC G10H 1/0066; G10H 2220/091

(57) ABSTRACT

Systems and methods of networking and managing audio effects processors for musical instruments and vocal microphones, in which multiple sets of parameter settings involved in audio effects processing can be stored as well as modified within a central management hub. In response to one or more simple user inputs, the respective sets of parameter settings can be recalled or otherwise accessed from the central management hub and applied to selected ones of the audio effects processors, thereby allowing both musicians and vocalists to create a multitude of characteristic sounds with their musical instruments and vocal microphones, respectively, with increased convenience and ease-of-use.

### CROSS REFERENCE TO RELATED APPLICATIONS

This application claims benefit of the priority of U.S. Provisional Patent Application No. 62/027,017 filed Jul. 21, 2014 entitled SYSTEM FOR NETWORKING AUDIO EFFECTS PROCESSORS, ENABLING BIDIRECTIONAL COMMUNICATION AND STORAGE/RECALL OF DATA.

### TECHNICAL FIELD

The present application relates generally to audio effects processors, and more specifically to systems and methods of networking and managing audio effects processors for use with musical instruments and vocal microphones.

### BACKGROUND

Musicians and vocalists frequently employ audio effects processors to alter the sound produced by their musical instruments and vocal microphones, respectively, during live performances and/or in the recording studio. Such audio effects processors can be implemented as pedal units, rackmount devices, or built-in units that can be incorporated into sound amplifiers or within the musical instruments and vocal microphones themselves. Such audio effects processors can be used by musicians and vocalists to create characteristic sounds that differ significantly from the raw, unprocessed sounds normally produced by their musical instruments and vocal microphones alone.

Audio effects processors implemented as pedal units (also referred to herein as “stompboxes” or “effects pedals”) are particularly popular among musicians such as guitarists and keyboardists due to their portability, versatility, and ease of use. A typical effects pedal can receive an audio input signal produced by a musical instrument such as a guitar or keyboard, perform audio effects processing on the audio input signal in the analog domain and/or the digital domain to produce a desired effect (e.g., a chorus effect, a flanging effect, a phaser effect, a ring modulation effect, a tremolo effect, a vibrato effect, etc.), and generate a processed audio output signal that can be provided to a sound amplifier for amplification. Such an effects pedal typically includes several knobs, pushbuttons, switches, sliders, and/or other user interfaces that the musicians can manipulate to set or adjust various parameters involved in the audio effects processing (e.g., parameters relating to volume, voice, tone, delay, rate, depth, feedback, mix, modulation, etc.), allowing the musicians to create many different characteristic sounds with their musical instruments. Some effects pedals also allow the musicians to store the parameter settings locally within the respective effects pedals for subsequent retrieval.

In order to increase the number of possible characteristic sounds, such musicians can use multiple effects pedals to produce a processed audio output signal that combines the different effects produced by the multiple effects pedals individually. For example, the multiple effects pedals can be arranged on a pedalboard, which can be configured to provide a jack bay as well as a power supply for the respective effects pedals. A typical pedalboard allows a number of effects pedals (e.g., up to 5 or any other suitable number) to be connected serially in an audio signal path, such that an output terminal of one effects pedal is connected to an input terminal of the next effects pedal, and so on. The typical pedalboard can include a bypass switch that the musicians can use to select one or more of the serially-connected effects pedals on the pedalboard for creating a desired characteristic sound, while bypassing (e.g., physically disconnecting) any unselected effects pedals from the audio signal path. Such a typical pedalboard can also receive control signals, such as musical instrument digital interface (MIDI) control signals, from an external controller device, such as a MIDI controller, and provide the control signals to one or more of the multiple effects pedals for use in selecting/bypassing and/or otherwise controlling certain ones of the effects pedals. In this way, more than one desired characteristic sound can be created without requiring the musicians to manipulate any user interfaces of the effects pedals directly.

The typical effects pedals and pedalboard described herein have several drawbacks, however. For example, because the various parameters involved in audio effects processing are set/adjusted and stored locally at the respective effects pedals, it can be complicated and time-consuming for musicians and vocalists when making any parameter changes, particularly if such parameter changes involve two, three, or more of the effects pedals on the pedalboard. Changing the parameters involved in audio effects processing can be especially problematic for such musicians and vocalists when engaged in a live performance. Moreover, it can be cumbersome and inconvenient for musicians to route control signals, particularly MIDI control signals, from the external controller device to the multiple effects pedals for individually selecting/bypassing and/or otherwise controlling certain ones of the effects pedals.

It would therefore be desirable to have systems and methods of networking and managing audio effects processors for musical instruments and vocal microphones that avoid at least some of the drawbacks of the typical effects pedals and pedalboard described herein.

### SUMMARY

In accordance with the present application, systems and methods of networking and managing audio effects processors for musical instruments and vocal microphones are disclosed, in which multiple sets of parameter settings that determine audio effects processing performed by the respective audio effects processors can be stored as well as modified within a central management hub. In response to one or more simple user inputs, the respective sets of parameter settings can be recalled or otherwise accessed from the central management hub and applied to selected ones of the audio effects processors, thereby allowing both musicians and vocalists to create a multitude of characteristic sounds with their musical instruments and vocal microphones, respectively, with increased convenience and ease-of-use.

In one aspect, a system for networking and managing audio effects processors for musical instruments and vocal microphones includes a central management hub, and one or more audio effects processors connectable to the central management hub. In an exemplary aspect, the audio effects processors can be implemented as effects pedals, and the respective effects pedals can be configured and arranged, as desired, on a pedalboard. The effects pedals can be connected serially in an audio signal path, such that an output terminal of one effects pedal is connected to an input terminal of the next effects pedal, and so on. The central management hub includes a microcontroller, a program/data memory (e.g., read-only memory (ROM), random access memory (RAM)), a nonvolatile (NV) preset memory, and a plurality of bidirectional multifunction ports, as well as one or more user interfaces such as a SCAN/SAVE pushbutton, a RECALL/COPY pushbutton, and one or more light emitting diodes (LEDs). The central management hub can further include a musical instrument digital interface (MIDI) input port, a MIDI output/thru port, and a universal serial bus (USB) port. The effects pedals can each likewise include a bidirectional multifunction port.

The plurality of bidirectional multifunction ports of the central management hub (or a subset thereof) can be connected to the bidirectional multifunction ports of the effects pedals, respectively, and the central management hub can communicate with the respective effects pedals over the interconnected ports using a predetermined communication protocol. In an exemplary aspect, the predetermined communication protocol defines a plurality of commands that can be issued by the central management hub to the respective effects pedals, including, but not limited to, a ping command, a get parameters command, and a set parameters command.

In one mode of operation, the central management hub can discover the number and logical locations of the effects pedals connected to it by sending, in response to a user's momentary actuation of the SCAN/SAVE pushbutton, a ping command over each of its bidirectional multifunction ports. In an exemplary aspect, a visual indication of the user's momentary actuation of the SCAN/SAVE pushbutton can be provided by a corresponding momentary illumination of one of the LEDs. In the event the bidirectional multifunction port of the central management hub is connected to a corresponding bidirectional multifunction port of an effects pedal, the central management hub can receive, in response to its sending of the ping command, a ping response from the effects pedal over the interconnected ports. In an exemplary aspect, the ping response can include at least an identifier and/or an address of the effects pedal, which the central management hub can subsequently use when sending commands (e.g., a ping command, a get parameters command, a set parameters command, etc.) and receiving responses to the commands, as appropriate, to/from that effects pedal.

Once the number and logical locations of the effects pedals have been discovered by the central management hub, the user (e.g., a musician or vocalist) can configure one, some, or all of the effects pedals by setting or adjusting one or more parameters (e.g., parameters relating to volume, voice, tone, delay, rate, depth, feedback, mix, modulation, etc.) involved in the audio effects processing performed by the respective effects pedal(s). For example, such parameter settings/adjustments can be made by the user's manipulation of one or more knobs, pushbuttons, switches, sliders, and/or other user interfaces associated with the effects pedals.

After the effects pedals connected to the central management hub have been configured by the user, the central management hub can store the parameter settings for the respective effects pedals in its NV preset memory. To that end, the central management hub can query each effects pedal by sending, in response to the user's extended actuation of the SCAN/SAVE pushbutton, a get parameters command to the effects pedal over the interconnected ports. In an exemplary aspect, a visual indication of the user's extended actuation of the SCAN/SAVE pushbutton can be provided by a corresponding extended illumination of one of the LEDs. The central management hub can then receive, over the interconnected ports in response to its sending of the get parameters command, a message from the effects pedal containing indications of its current parameter settings, as well as its audio effects on/off state.

Having received the current parameter settings from each effects pedal connected to it, the central management hub can store the set of parameter settings for the respective effects pedals in the NV preset memory at a default memory address (e.g., address 0 or any other suitable address). In an exemplary aspect, the extended illumination of the LED, resulting from the user's extended actuation of the SCAN/SAVE pushbutton, can be extinguished once the set of parameter settings are stored in the NV preset memory. The set of parameter settings stored in the NV preset memory at the default memory address is referred to herein collectively as a “parameter settings configuration”. In a further exemplary aspect, a personal computer or tablet computer can be connected to the USB port of the central management hub for modifying, via a graphical user interface (GUI), the parameter settings configuration(s) and audio effects on/off state(s) stored in the NV preset memory. It is noted that such modification of the parameter settings configuration(s) and/or audio effects on/off state(s) can alternatively be performed over a Bluetooth connection, a WiFi connection, or any other suitable connection between the personal or tablet computer and the central management hub. In response to the user's momentary actuation of the RECALL/COPY pushbutton, the central management hub can recall or otherwise access the parameter settings configuration stored in the NV preset memory at the default memory address, and send a set parameters command to each of the effects pedals over the interconnected ports, thereby restoring the set of parameter settings corresponding to the parameter settings configuration at the respective effects pedals. As with the user's actuation of the SCAN/SAVE pushbutton, a visual indication of the user's momentary actuation of the RECALL/COPY pushbutton can be provided by a corresponding momentary illumination of one of the LEDs.

In an exemplary aspect, a MIDI controller connected to the MIDI input port of the central management hub can be used to specify at least one memory address at which to store, in the NV preset memory, at least one parameter settings configuration for the respective effects pedals by sending at least one MIDI program change command to the central management hub via the MIDI input port. Having received a first specified memory address included in a first MIDI program change command, the central management hub can store, in response to the user's extended actuation of the SCAN/SAVE pushbutton, the parameter settings configuration for the respective effects pedals in the NV preset memory at the first specified memory address. Further, in response to the user's momentary actuation of the RECALL/COPY pushbutton, the central management hub can recall or otherwise access the parameter settings configuration stored in the NV preset memory at the first specified memory address, and send a set parameters command to each of the effects pedals over the interconnected ports to restore the set of parameter settings corresponding to the parameter settings configuration at the respective effects pedals.

Moreover, in the event a second specified memory address included in a second MIDI program change command is received at the central management hub, the central management hub can optionally copy, in response to the user's extended actuation of the RECALL/COPY pushbutton, the parameter settings configuration stored at the first specified memory address location within the NV preset memory to the second specified memory address location within the NV preset memory. As with the user's actuation of the SCAN/SAVE pushbutton, a visual indication of the user's extended actuation of the RECALL/COPY pushbutton can be provided by a corresponding extended illumination of one of the LEDs, which can be extinguished once the set of parameter settings have been copied within the NV preset memory.

In a further exemplary aspect, the functions of (1) receiving a specified memory address at the central management hub from the MIDI controller, and (2) storing a parameter settings configuration in the NV preset memory at the specified memory address, can be repeated multiple times for storing a plurality of parameter settings configurations in the NV preset memory at a plurality of specified memory addresses, respectively. Further, in response to one or more simple user inputs (e.g., the user's actuation of a pushbutton or footswitch associated with the MIDI controller), the MIDI controller can send one or more MIDI program change commands, each including an indication of one of the plurality of specified memory addresses, to the central management hub, thereby causing the central management hub (1) to recall or otherwise access the parameter settings configuration stored in the NV preset memory at the specified memory address, and (2) to send a set parameters command to each of the effects pedals over the interconnected ports to restore the set of parameter settings corresponding to the parameter settings configuration at the respective effects pedals. In this way, a number of different parameter settings configurations (e.g., up to 128 or any other suitable number) can be recalled/accessed from the NV preset memory, and corresponding sets of parameter settings can be restored at the respective effects pedals, in response to the user's repeated actuation of the pushbutton or footswitch associated with the MIDI controller.

By providing a central management hub that can be used to store as well as modify multiple sets of parameter settings involved in audio effects processing, and to apply the respective sets of parameter settings to selected ones of a plurality of audio effects processors, both musicians and vocalists can create a multitude of characteristic sounds with their musical instruments and vocal microphones, respectively, with increased convenience and ease-of-use.

Other features, functions, and aspects of the invention will be evident from the Detailed Description that follows.

### BRIEF DESCRIPTION OF THE DRAWINGS

The accompanying drawings, which are incorporated in and constitute a part of this specification, illustrate one or more embodiments described herein and, together with the Detailed Description, explain these embodiments. In the drawings:

FIG. 1a is a diagram of a conventional audio effects processor connected between a musical instrument and a sound amplifier;

FIG. 1b is a diagram of a plurality of conventional audio effects processors connected between the musical instrument and the sound amplifier of FIG. 1a;

FIG. 2a is a block diagram of an exemplary central management hub, in accordance with the present application;

FIG. 2b is a diagram of an exemplary multifunction port connector configured for use with the central management hub of FIG. 2a;

FIG. 3 is a diagram illustrating an exemplary use of the central management hub of FIG. 2a with an audio effects processor connected between a musical instrument and a sound amplifier;

FIG. 4a is a diagram illustrating exemplary parallel connections between the central management hub of FIG. 2a and a plurality of serially-connected audio effects processors, which, in turn, are connected between the musical instrument and the sound amplifier of FIG. 3;

FIG. 4b is a diagram illustrating an exemplary serial bus connection between the central management hub of FIG. 2a and the plurality of audio effects processors of FIG. 4a;

FIG. 4c is a diagram illustrating the exemplary parallel connections between the central management hub of FIG. 2a and the plurality of audio effects processors of FIG. 4a, as well as an exemplary musical instrument digital interface (MIDI) controller connected to the central management hub of FIG. 2a;

FIG. 4d is a diagram illustrating the exemplary parallel connections between the central management hub of FIG. 2a and the plurality of audio effects processors of FIG. 4a, as well as an exemplary personal computer connected to the central management hub of FIG. 2a;

FIG. 4e is an exemplary graphical user interface (GUI) provided by the personal computer of FIG. 4d for use in networking and managing the plurality of audio effects processors of FIG. 4a parallel-connected to the central management hub of FIG. 2a;

FIG. 4f is a diagram illustrating the exemplary parallel connections between the central management hub of FIG. 2a and the plurality of audio effects processors of FIG. 4a, as well as an exemplary expression pedal connected to the central management hub of FIG. 2a;

FIG. 5 is a diagram illustrating an exemplary bypass device connected to both the central management hub of FIG. 2a and an audio effects processor that is not compatible with the central management hub of FIG. 2a, the bypass device being further connected between the musical instrument and the sound amplifier of FIG. 3;

FIG. 6 is a diagram illustrating exemplary parallel connections between the central management hub of FIG. 2a and a plurality of serially-connected audio effects processors, the plurality of audio effects processors being connected between the musical instrument and the sound amplifier of FIG. 3, each of the plurality of audio effects processors being further connected to an external power source, and the MIDI controller of FIG. 4c being connected to the central management hub of FIG. 2a;

FIG. 7a is a diagram illustrating exemplary parallel connections between an alternative embodiment of the central management hub of FIG. 2a and a plurality of audio effects processors, in which the alternative embodiment is configured to reduce the number of cords and/or cables required for providing power, communications, and/or audio signals to/from the respective audio effects processors;

FIG. 7b is a diagram of an exemplary multifunction port connector configured for use with the alternative embodiment of the central management hub of FIG. 7a; and

FIG. 8 is a flow diagram illustrating an exemplary method of operating the central management hub of FIG. 2a.

### DETAILED DESCRIPTION

The disclosure of U.S. Provisional Patent Application No. 62/027,017 filed Jul. 21, 2014 entitled SYSTEM FOR NETWORKING AUDIO EFFECTS PROCESSORS, ENABLING BIDIRECTIONAL COMMUNICATION AND STORAGE/RECALL OF DATA is hereby incorporated herein by reference in its entirety.

Systems and methods of networking and managing audio effects processors for musical instruments and vocal microphones are disclosed, in which multiple sets of parameter settings involved in audio effects processing can be stored as well as modified within a central management hub. In response to one or more simple user inputs, the respective sets of parameter settings can be recalled or otherwise accessed from the central management hub and applied to selected ones of the audio effects processors, thereby allowing both musicians and vocalists to create a multitude of characteristic sounds with their musical instruments and vocal microphones, respectively, with increased convenience and ease-of-use.

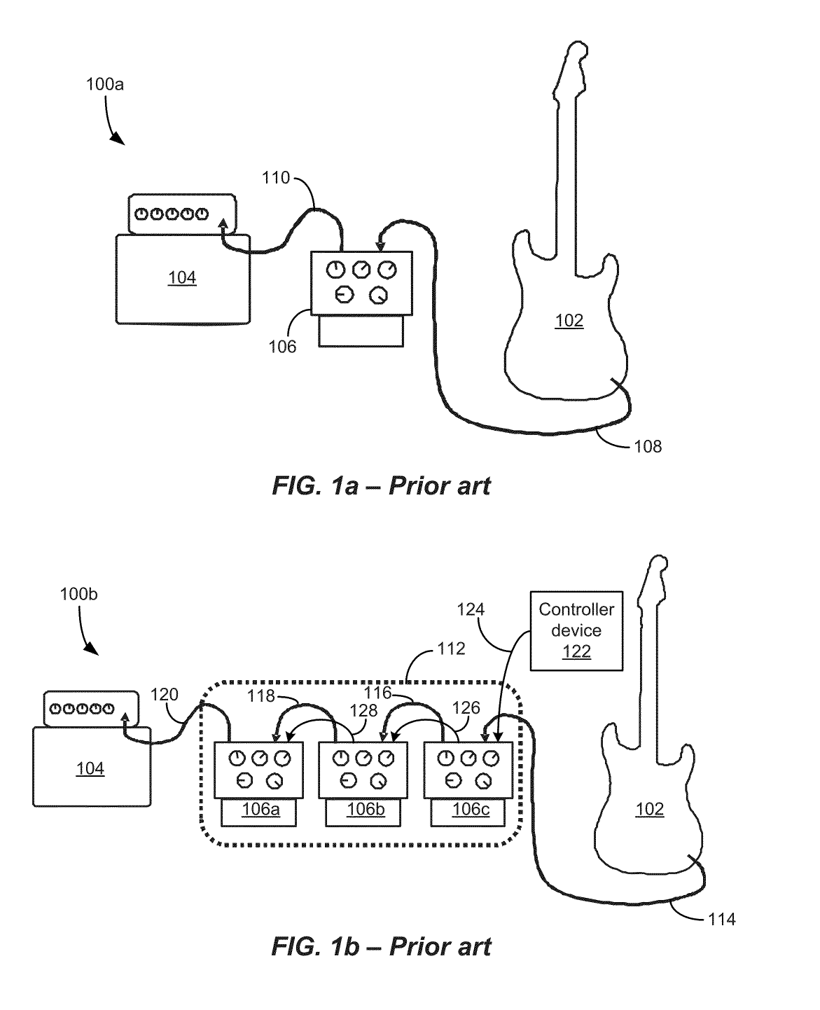

FIG. 1a depicts a conventional arrangement for providing audio effects processing in a system 100a that includes a musical instrument 102, a sound amplifier 104, and an audio effects processor 106. For example, the musical instrument 102 can be an electric guitar or any other suitable musical instrument, and the audio effects processor 106 can be implemented as a pedal unit (also referred to herein as a “stompbox” or “effects pedal”) or any other suitable audio effects processor implementation. In the conventional arrangement of FIG. 1a, the effects pedal 106 can receive, over a cable 108, an audio input signal produced by the electric guitar 102, and perform audio effects processing on the audio input signal in the analog domain and/or the digital domain to produce a desired effect (e.g., a chorus effect, a flanging effect, a phaser effect, a ring modulation effect, a tremolo effect, a vibrato effect, etc.). The effects pedal 106 can further generate a processed audio output signal, which can be provided, over a cable 110, to the sound amplifier 104 for amplification. The effects pedal 106 can include several knobs, pushbuttons, switches, sliders, and/or other user interfaces that a musician (e.g., a guitarist) can manipulate to set or adjust various parameters involved in the audio effects processing (e.g., parameters relating to volume, voice, tone, delay, rate, depth, feedback, mix, modulation, etc.), allowing him or her to create a number of different characteristic sounds with the electric guitar 102. The effects pedal 106 is typically configured to store the parameter settings locally within its internal nonvolatile (NV) memory for subsequent retrieval.

FIG. 1b depicts another conventional arrangement for providing audio effects processing in a system 100b that includes the electric guitar 102, the sound amplifier 104, and multiple effects pedals 106a, 106b, 106c (e.g., 3 effects pedals or any other suitable number of effects pedals) arranged on a pedalboard 112. In the conventional arrangement of FIG. 1b, the multiple effects pedals 106a, 106b, 106c are connected serially in an audio signal path, such that an output terminal of the electric guitar 102 is connected by a cable 114 to an input terminal of the effects pedal 106c, an output terminal of the effects pedal 106c is connected by a cable 116 to an input terminal of the effects pedal 106b, an output terminal of the effects pedal 106b is connected by a cable 118 to an input terminal of the effects pedal 106a, and an output terminal of the effects pedal 106a is connected by a cable 120 to an input terminal of the sound amplifier 104. Like the effects pedal 106 (see FIG. 1a), each of the effects pedals 106a, 106b, 106c is typically configured to store settings of parameters involved in its audio effects processing locally within its internal NV memory for subsequent retrieval.

With regard to the conventional arrangement of FIG. 1b, the pedalboard 112 can include a bypass switch that the guitarist can use to select one or more of the effects pedals 106a, 106b, 106c for creating a desired characteristic sound, while bypassing (e.g., physically disconnecting) any unselected ones of the effects pedals 106a, 106b, 106c from the audio signal path. Further, the pedalboard 112 can receive control signals, such as musical instrument digital interface (MIDI) control signals, from an external controller device 122, such as a MIDI controller, and provide the control signals to one or more of the effects pedals 106a, 106b, 106c for use in selecting/bypassing and/or otherwise controlling certain ones of the effects pedals 106a, 106b, 106c. For example, an output port of the controller device 122 can be connected by a cable 124 to an input port of the effects pedal 106c, an output/thru port of the effects pedal 106c can be connected by a cable 126 to an input port of the effects pedal 106b, and an output/thru port of the effects pedal 106b can be connected by a cable 128 to an input port of the effects pedal 106a. In this way, more than one desired characteristic sound can be created with the electric guitar 102 without requiring the guitarist to manipulate any user interfaces (e.g., knobs, pushbuttons, switches, sliders, etc.) of the effects pedals 106a, 106b, 106c directly.

The effects pedals 106, 106a, 106b, 106c and the pedalboard 112 described herein with reference to the conventional arrangements of FIGS. 1a and 1b have several drawbacks, however. For example, because the various parameters involved in audio effects processing are set/adjusted and stored locally within the internal NV memories of the respective effects pedals 106, 106a, 106b, 106c, it can be complicated and time-consuming for musicians and vocalists when making any parameter changes, particularly if such parameter changes involve two, three, or more such effects pedals. Changing the parameters involved in audio effects processing can be especially problematic for such musicians and vocalists when engaged in a live performance. Moreover, it can be cumbersome and inconvenient to route control signals, particularly MIDI control signals, over the several cables 124, 126, 128 from the external controller device 122 to the effects pedals 106c, 106b, 106a, respectively, for individually selecting/bypassing and/or otherwise controlling certain ones of the effects pedals 106a, 106b, 106c.

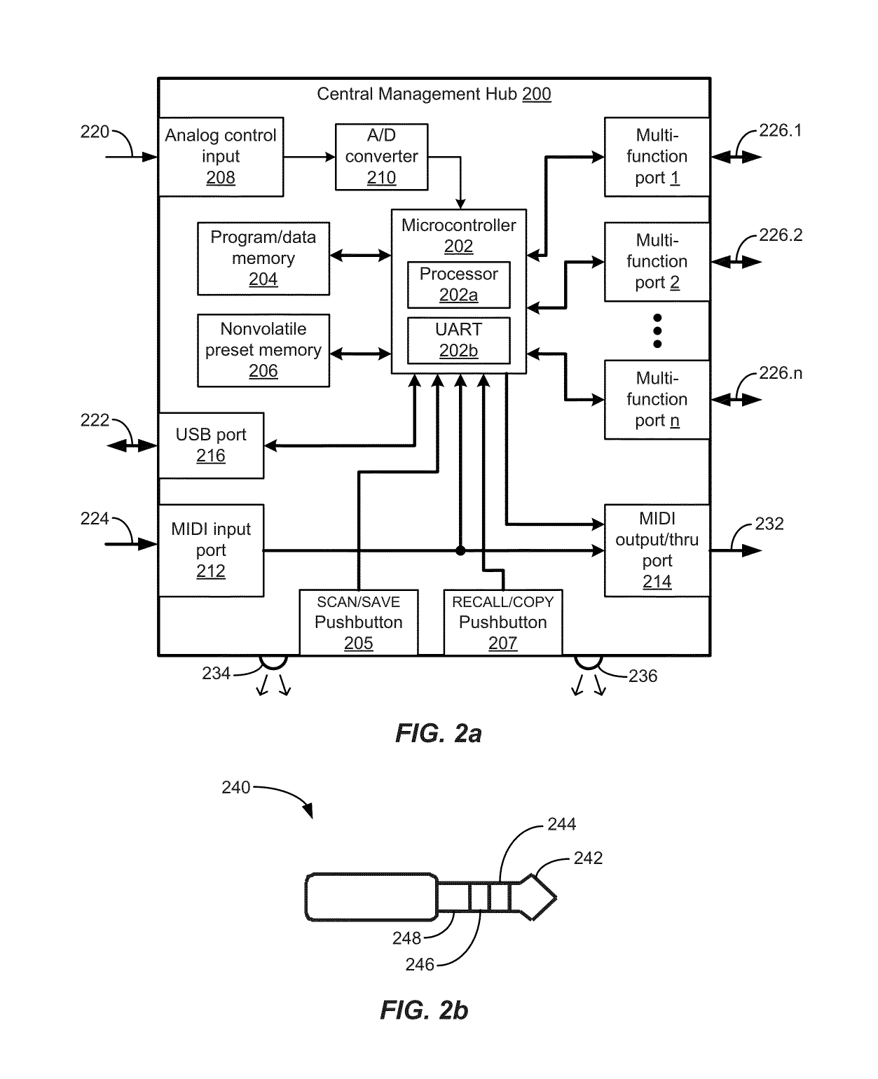

FIG. 2a depicts an illustrative embodiment of an exemplary central management hub 200, which can be used by musicians and vocalists to network and manage one or more audio effects processors for musical instruments and vocal microphones, respectively, in accordance with the present application. As shown in FIG. 2a, the central management hub 200 includes a microcontroller 202, a program/data memory 204, a nonvolatile (NV) preset memory 206, and a plurality of bidirectional multifunction ports 1, 2, . . . , n, as well as one or more user interfaces such as a SCAN/SAVE pushbutton 205, a RECALL/COPY pushbutton 207, and a plurality of light emitting diodes (LEDs) graphically illustrated at reference numerals 234, 236. The microcontroller 202 can include at least one processor 202a, and a universal asynchronous receiver-transmitter (UART) 202b. The central management hub 200 further includes a musical instrument digital interface (MIDI) input port 212, an optional MIDI output/thru port 214, a universal serial bus (USB) port 216, an analog control input 208, and an analog-to-digital (A/D) converter 210 connected between the analog control input 208 and the microcontroller 202.

As further shown in FIG. 2a, the analog control input 208 can receive an analog control input over an analog input path 220, and provide the analog control input to the A/D converter 210, which, in turn, can provide a corresponding control input in digital form to the microcontroller 202. For example, the analog control input can be provided over the analog input path 220 by an expression pedal (e.g., a volume pedal), or any other suitable analog control input device. The USB port 216 can receive/send serial data between the microcontroller 202 and a bidirectional data path 222. For example, the serial data can be received/sent over the bidirectional data path 222 by a personal computer, a tablet computer, or any other suitable computerized device. The MIDI input port 212 can receive MIDI input data over a data input path 224, and provide the MIDI input data to the microcontroller 202 for subsequent processing or directly to the optional MIDI output/thru port 214, which, in turn, can send MIDI output data over a data output path 232. For example, the MIDI input data can be provided over the data input path 224 by any suitable MIDI controller device. The bidirectional multifunction ports 1, 2, . . . , n can send serial control data (e.g., one or more commands) over bidirectional data paths 226.1, 226.2, . . . , 226.n, respectively, from the microcontroller 202 to one or more audio effects processors (e.g., one or more effects pedals), as well as receive serial response data over the bidirectional data paths 226.1, 226.2, . . . , 226.n, respectively, from the respective effects pedal(s) for subsequent forwarding to the microcontroller 202. In one embodiment, the central management hub 200 can send/receive serial data over the bidirectional data paths 226.1, 226.2, . . . , 226.n using the UART 202b included in the microcontroller 202.

FIG. 2b depicts an exemplary multifunction port connector 240 configured for use with a suitable cable for sending/receiving serial data between one of the bidirectional multifunction ports 1, 2, . . . , n of the central management hub 200 (see FIG. 2a) and a corresponding bidirectional multifunction port of an effects pedal. As shown in FIG. 2b, in one embodiment, the multifunction port connector 240 can be configured as a 4-conductor, ⅛ inch TRRS (tip-ring-ring-sleeve) plug, including a tip 242, a first ring 244, a second ring 246, and a sleeve 248. In this embodiment of the multifunction port connector 240, the tip 242 is operative to carry power (as desired and/or required), the first ring 244 is operative to handle serial receive data, the second ring 246 is operative to handle serial send data, and the sleeve 248 is operative to provide a ground reference.

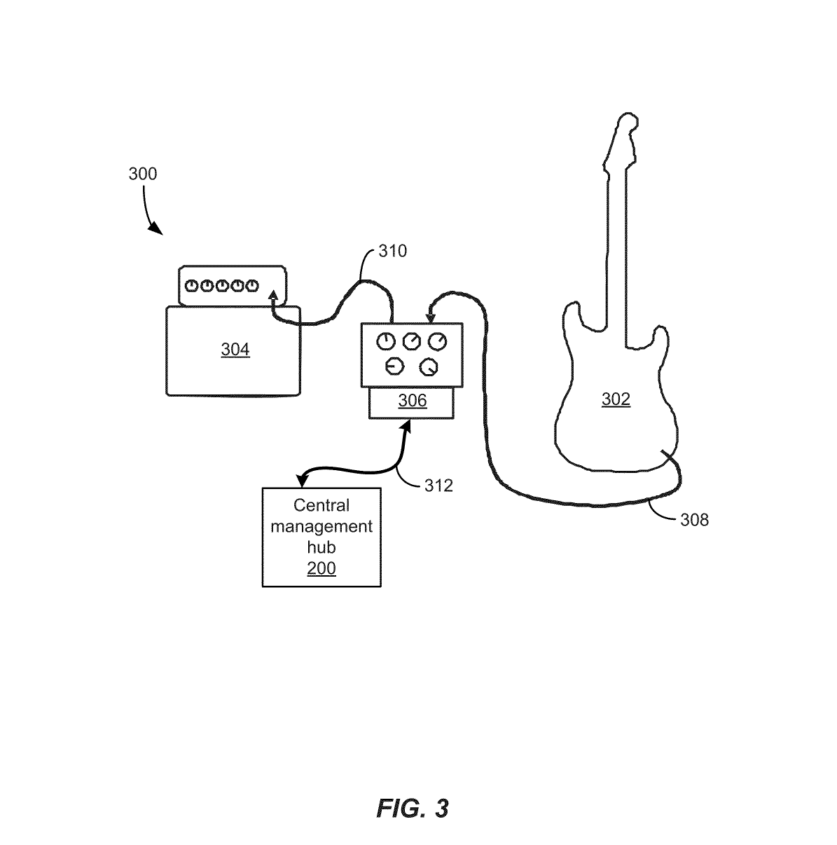

FIG. 3 depicts a system 300 that illustrates an exemplary use of the central management hub 200 of FIG. 2a with an effects pedal 306, which is connected between an electric guitar 302 and a sound amplifier 304. As shown in FIG. 3, the effects pedal 306 can receive, over a cable 308, an audio input signal produced by the electric guitar 302, and perform audio effects processing on the audio input signal in the analog domain and/or the digital domain to produce a desired effect (e.g., a chorus effect, a flanging effect, a phaser effect, a ring modulation effect, a tremolo effect, a vibrato effect, etc.). The effects pedal 306 can further generate a processed audio output signal, which can be provided, over a cable 310, to the sound amplifier 304 for amplification. The effects pedal 306 can include several knobs, pushbuttons, switches, sliders, and/or other user interfaces that a musician (e.g., a guitarist) can manipulate to set or adjust various parameters involved in the audio effects processing (e.g., parameters relating to volume, voice, tone, delay, rate, depth, feedback, mix, modulation, etc.), allowing him or her to create many different characteristic sounds with the electric guitar 302. Like the central management hub 200, the effects pedal 306 can be configured to include at least one bidirectional multifunction port, which can be connected, using a cable 312, directly to one of the bidirectional multifunction ports 1, 2, . . . , n of the central management hub 200 via a corresponding one of the bidirectional data paths 226.1, 226.2, . . . , 226.n. Whereas the effects pedal 106 in the conventional arrangement of FIG. 1a is typically configured to store settings of parameters involved in audio effects processing locally within its internal NV memory, the parameter settings involved in audio signal processing at the effects pedal 306, as well as its audio effects on/off state, are implemented in software such that they can be stored, external to the effects pedal 306, within the NV preset memory 206 (see FIG. 2a) of the central management hub 200.

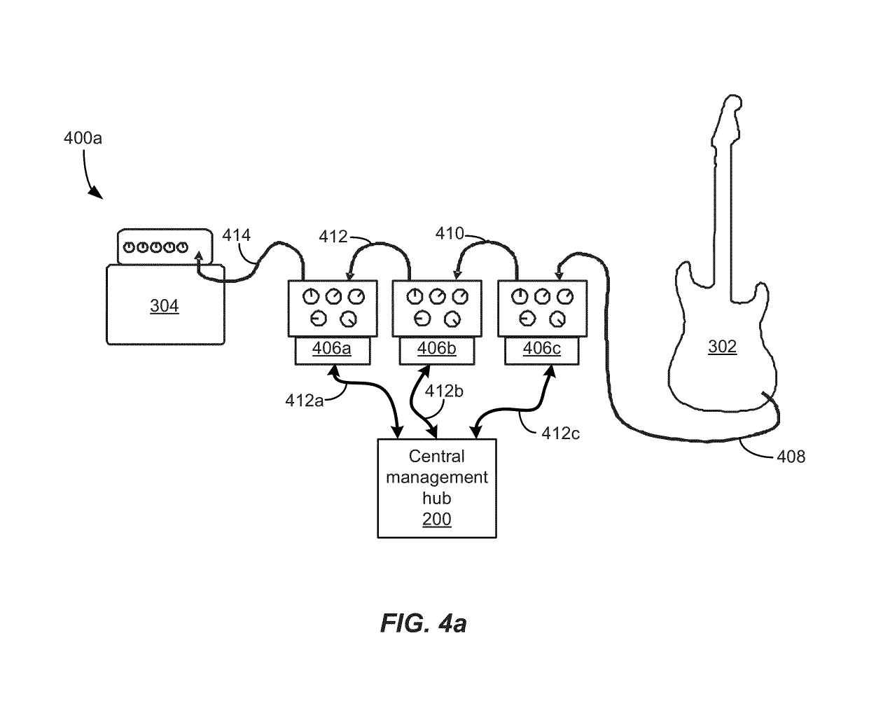

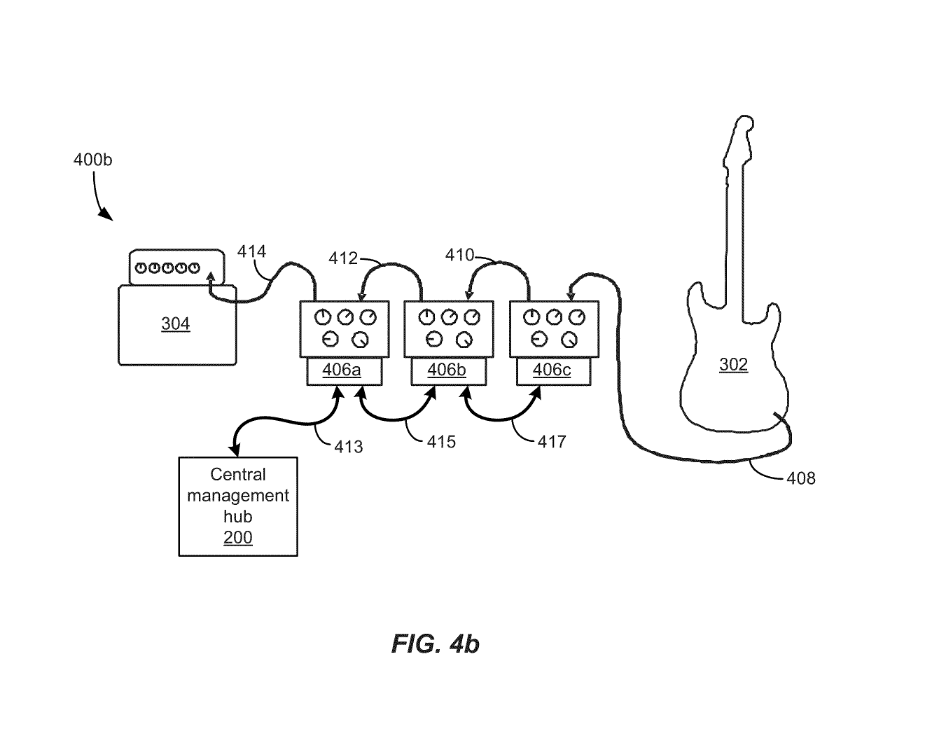

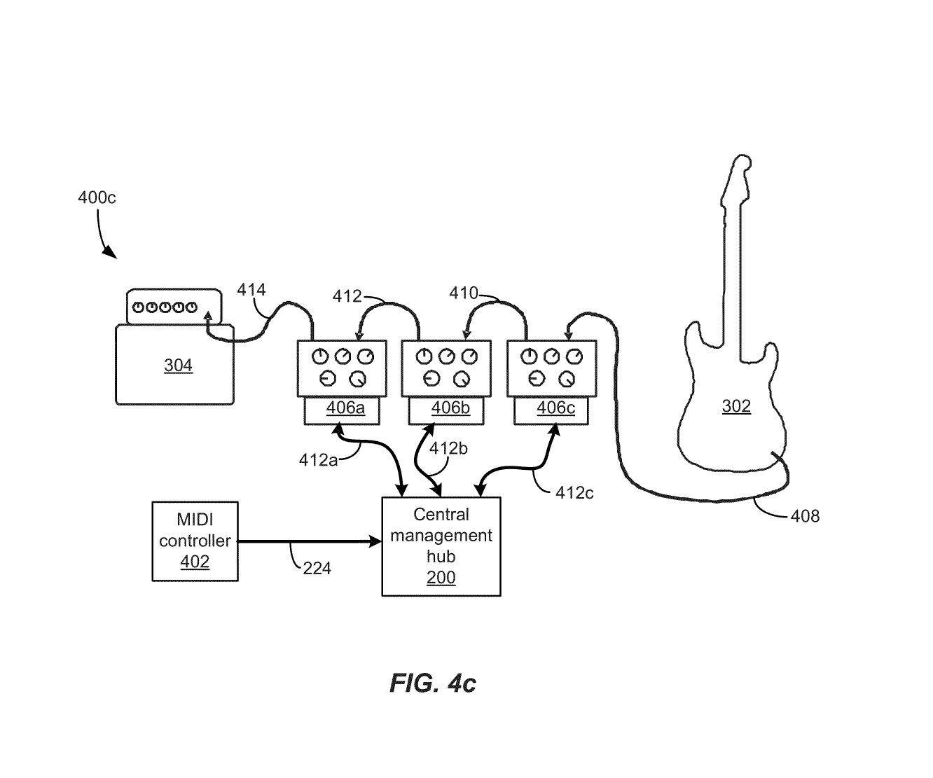

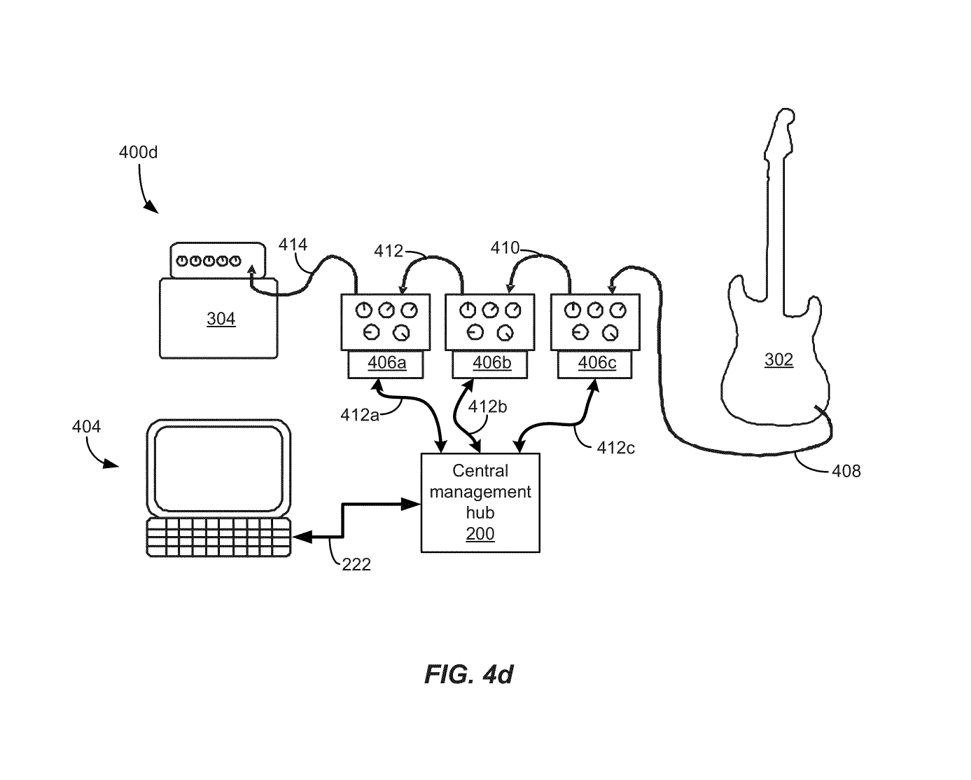

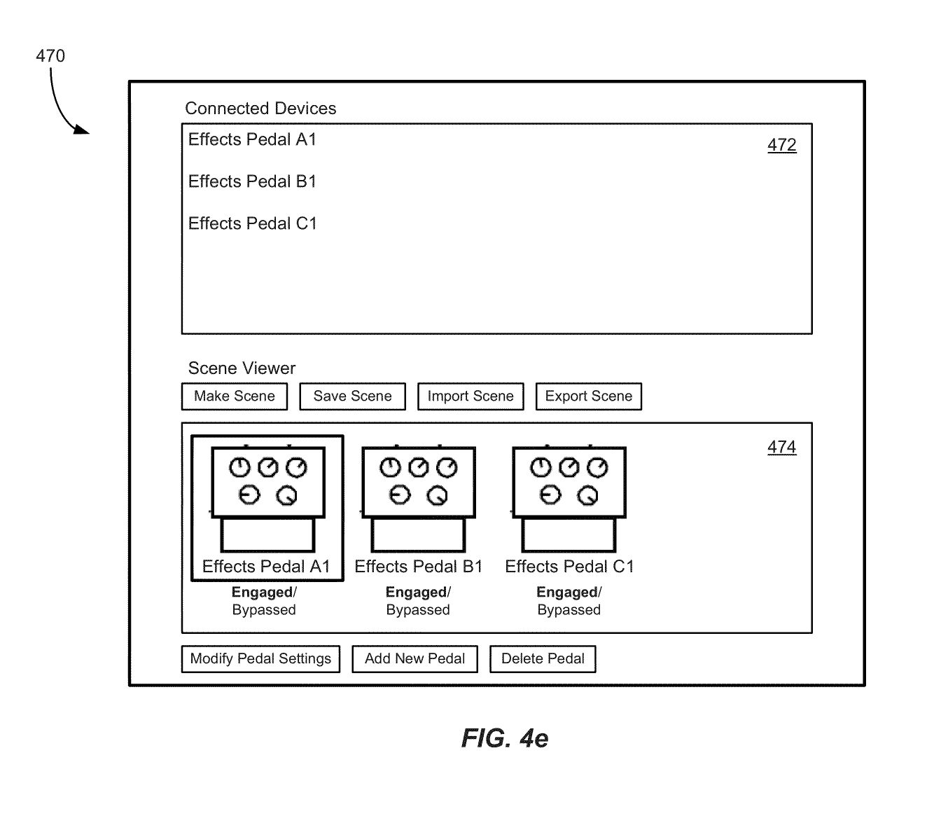

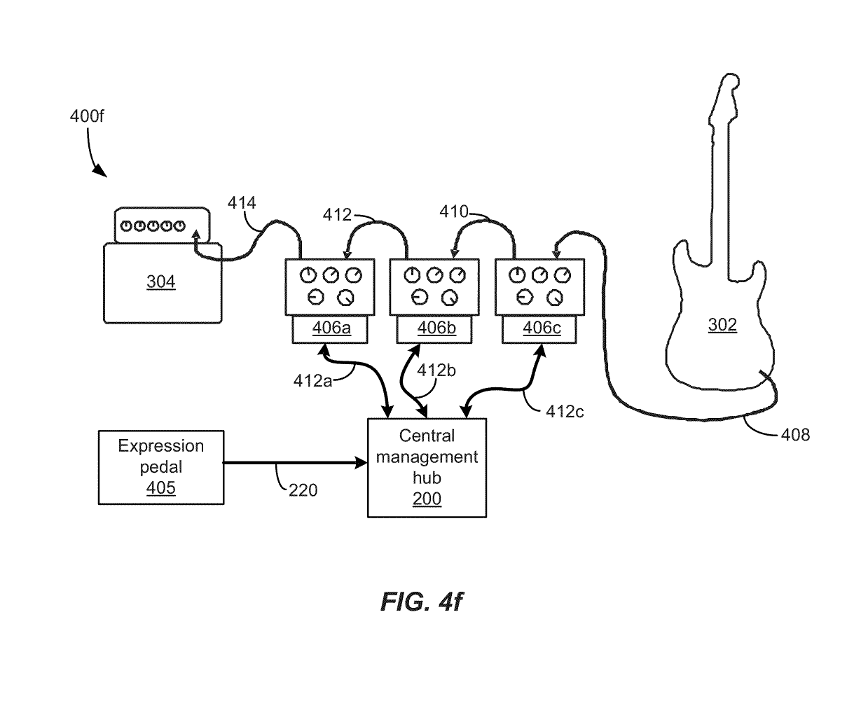

FIG. 4a depicts an exemplary system 400a that includes a number of parallel connections between the central management hub 200 of FIG. 2a and a plurality of serially-connected effects pedals 406a, 406b, 406c (e.g., 3 effects pedals or any other suitable number of effects pedals), which, in turn, are connected between the electric guitar 302 and the sound amplifier 304 of FIG. 3. In one embodiment, the effects pedals 406a, 406b, 406c can be arranged on a pedalboard (not shown). The plurality of effects pedals 406a, 406b, 406c are connected serially in an audio signal path, such that an output terminal of the electric guitar 302 is connected by a cable 408 to an input terminal of the effects pedal 406c, an output terminal of the effects pedal 406c is connected by a cable 410 to an input terminal of the effects pedal 406b, an output terminal of the effects pedal 406b is connected by a cable 412 to an input terminal of the effects pedal 406a, and an output terminal of the effects pedal 406a is connected by a cable 414 to an input terminal of the sound amplifier 304.

The plurality of effects pedals 406a, 406b, 406c (see FIG. 4a) are directly parallel-connected to the central management hub 200 by a plurality of cables 412a, 412b, 412c, respectively. Like the central management hub 200, each of the effects pedals 406a, 406b, 406c can be configured to include at least one bidirectional multifunction port, and the bidirectional multifunction ports of the respective effects pedals 406a, 406b, 406c can be parallel-connected, using the cables 412a, 412b, 412c, respectively, directly to corresponding ones of the bidirectional multifunction ports 1, 2, . . . , n of the central management hub 200 via corresponding ones of the bidirectional data paths 226.1, 226.2, . . . , 226.n. As with the parameter settings involved in audio signal processing at the effects pedal 306 (see FIG. 3), the parameter settings involved in audio signal processing at the respective effects pedals 406a, 406b, 406c (e.g., parameters relating to volume, voice, tone, delay, rate, depth, feedback, mix, modulation, etc.), as well as their audio effects on/off states, are implemented in software such that they can be stored, external to the respective effects pedals 406a, 406b, 406c, within the NV preset memory 206 (see FIG. 2a) of the central management hub 200.

FIG. 4b depicts an exemplary system 400b that includes a serial bus connection between the central management hub 200 of FIG. 2a and the plurality of serially-connected effects pedals 406a, 406b, 406c, which, in turn, are connected between the electric guitar 302 and the sound amplifier 304 of FIG. 3. With reference to the serial bus connection illustrated in FIG. 4b, each of the effects pedals 406a, 406b, 406c can be configured to include first and second (i.e., 2) bidirectional multifunction ports. Further, one of the bidirectional multifunction ports 1, 2, . . . , n of the central management hub 200 and the respective bidirectional multifunction ports of the effects pedals 406a, 406b, 406c can be serially-connected using a plurality of cables 413, 415, 417. For example, the bidirectional multifunction port 1, 2, . . . , or n of the central management hub 200 can be connected by the cable 413 directly to a first bidirectional multifunction port of the effects pedal 406a, a second bidirectional multifunction port of the effects pedal 406a can be connected by the cable 415 directly to a first bidirectional multifunction port of the effects pedal 406b, and a second bidirectional multifunction port of the effects pedal 406b can be connected by the cable 417 directly to a bidirectional multifunction port of the effects pedal 406c. As described herein with reference to FIG. 4a, the parameter settings involved in audio signal processing at the respective effects pedals 406a, 406b, 406c (e.g., parameters relating to volume, voice, tone, delay, rate, depth, feedback, mix, modulation, etc.), as well as their audio effects on/off states, are implemented in software such that they can be stored, external to the respective effects pedals 406a, 406b, 406c, within the NV preset memory 206 (see FIG. 2a) of the central management hub 200.

FIGS. 4c, 4d, and 4f depict exemplary systems 400c, 400d, and 400f, respectively, which provide further illustrations of the parallel connections between the central management hub 200 of FIG. 2a and the plurality of serially-connected effects pedals 406a, 406b, 406c connected between the electric guitar 302 and the sound amplifier 304 of FIG. 3. FIG. 4c further illustrates a MIDI controller 402 operative to provide MIDI input data (e.g., one or more MIDI commands) to the central management hub 200 over the data input path 224. In one embodiment, the MIDI commands can be implemented as data packets based on the MIDI program change format, or any other suitable format. FIG. 4d further illustrates a personal computer 404 operative to send/receive serial data to/from the central management hub 200 over the bidirectional data path 222. FIG. 4f further illustrates an expression pedal 405 (e.g., a volume pedal) operative to provide, over the analog input path 220, an analog control input to the central management hub 200, which, in turn, can provide the analog control input to the respective effects pedals 406a, 406b, 406c for use in their audio effects processing.

The plurality of bidirectional multifunction ports 1, 2, . . . , n of the central management hub 200 (or a subset thereof) can be connected to the bidirectional multifunction ports of a plurality of effects pedals, respectively, and the central management hub 200 can communicate with the respective effects pedals over the interconnected ports using a predetermined communication protocol. In one embodiment, the predetermined communication protocol defines a plurality of commands that can be issued by the central management hub 200 to the respective effects pedals, including, but not limited to, a ping command, a get parameters command, a set parameters command, an NV memory read command, an NV memory write command, and a bypass command, the functions of which are as follows:
Ping command: Discover the number and logical locations of the effects pedals connected to the central management hub 200. In response to the ping command, each connected effects pedal can send a ping response that can include at least an identifier (e.g., a product ID, a device ID) and/or an address of the effects pedal, which the central management hub 200 can subsequently use when sending commands to or otherwise communicating with that effects pedal.
Get parameters command: Obtain a set of software parameter settings of one or more effects pedals connected to the central management hub 200 for subsequent storage in the NV preset memory 206. Such software parameter settings can be set or adjusted by a user by manipulating selected knobs, pushbuttons, switches, sliders, and/or other user interfaces of the respective effects pedals.
Set parameters command: Restore a set of software parameter settings, currently stored in the NV preset memory 206, at one or more effects pedals connected to the central management hub 200.
NV memory read command: Read an internal NV memory location of one or more effects pedals connected to the central management hub 200.
NV memory write command: Write to an internal NV memory location of one or more effects pedals connected to the central management hub 200.
Bypass command: Place one or more effects pedals connected to the central management hub 200 in a bypass (effectively “disconnected”) state. In the bypass state, an audio effect that can be produced by a respective effects pedal in the audio signal path is effectively turned “off”, and the audio input to that effects pedal is passed directly to its audio output essentially unchanged.

In one embodiment, the commands defined by the predetermined communication protocol can be issued by the central management hub 200 in a global manner, in which each of the plurality of effects pedals (e.g., the effects pedals 406a, 406b, 406c; see FIG. 4a) receives the same command data. In this case, each of the effects pedals 406a, 406b, 406c can parse the incoming command data, and determine whether any response or other action specific to that effects pedal is required based on the contents of the command. If it is determined that no response or other action specific to that effects pedal is required, then the effects pedal can ignore the command. When such global commands are being employed, all of the effects pedals 406a, 406b, 406c can share the same serial communication paths. Each of the effects pedals 406a, 406b, 406c therefore drives a respective one of the serial communication paths only when requested to do so by the central management hub 200. When the respective serial communication paths are not being driven by one of the effects pedals 406a, 406b, 406c, the serial communication paths can be tri-stated.

In a further embodiment, the commands defined by the predetermined communication protocol can be isolated to a particular bidirectional multifunction port. In this case, only the effects pedal 406a, 406b, or 406c connected to that bidirectional multifunction port will be capable of receiving command data from the central management hub 200 and issuing a response to the command. Such isolation of commands to a particular bidirectional multifunction port can be useful when the central management hub 200 is not yet aware of the type of effects pedal that is connected to that particular bidirectional multifunction port.

The operation of the central management hub 200 will be further understood with reference to the following illustrative example, in which the central management hub 200 is connected to the plurality of serially-connected effects pedals 406a, 406b, 406c by a corresponding plurality of parallel connections (implemented by the cables 412a, 412b, 412c; see FIG. 4a). In this example, the central management hub 200 (see also FIG. 2a) discovers the number and logical locations of the effects pedals 406a, 406b, 406c connected to it by sending, in response to a user's momentary actuation of the SCAN/SAVE pushbutton 205, a ping command over each of its bidirectional multifunction ports 1, 2, . . . , n. A visual indication of the user's momentary actuation of the SCAN/SAVE pushbutton 205 is provided by a corresponding momentary illumination of the light emitting diode (LED) 234. In response to its sending of the ping command, the central management hub 200 receives a ping response from each of the effects pedals 406a, 406b, 406c over the cables 412a, 412b, 412c, respectively. The ping response includes at least an identifier (e.g., the product ID, the device ID) and/or an address of the respective effects pedal 406a, 406b, or 406c, which the central management hub 200 can subsequently use when sending commands (e.g., a ping command, a get parameters command, a set parameters command, etc.) and receiving responses, as appropriate, to/from that effects pedal 406a, 406b, or 406c.

Once the number and logical locations of the effects pedals 406a, 406b, 406c have been discovered by the central management hub 200, the user (e.g., a musician or vocalist) can configure one, some, or all of the effects pedals 406a, 406b, 406c by setting or adjusting one or more parameters involved in the audio effects processing performed by the respective effects pedal(s) 406a, 406b, and/or 406c (e.g., parameters relating to volume, voice, tone, delay, rate, depth, feedback, mix, modulation, etc.). For example, such parameter settings/adjustments can be made by the user's manipulation of one or more knobs, pushbuttons, switches, sliders, and/or other user interfaces associated with the respective effects pedals 406a, 406b, 406c.

After the effects pedals 406a, 406b, 406c connected to the central management hub 200 have been configured by the user, the central management hub 200 can store the parameter settings for the respective effects pedals 406a, 406b, 406c, as well as their audio effects on/off states, in its NV preset memory 206. To that end, the central management hub 200 can query each effects pedal 406a, 406b, or 406c by sending, in response to the user's extended actuation of the SCAN/SAVE pushbutton 205, a get parameters command to the effects pedal 406a, 406b, or 406c via the corresponding cable 412a, 412b, or 412c. The central management hub 200 can then receive, in response to its sending of the get parameters command, a message from the effects pedal 406a, 406b, or 406c containing its current software parameter settings and audio effects on/off state.

Having received the current software parameter settings and audio effects on/off state for each of the effects pedals 406a, 406b, 406c connected to it, the central management hub 200 can store the set of parameter settings and audio effects on/off states for the respective effects pedals 406a, 406b, 406c in the NV preset memory 206 at a default memory address (e.g., address 0 or any other suitable address). A visual indication of the user's extended actuation of the SCAN/SAVE pushbutton 205 can be provided by a corresponding extended illumination of the LED 234, which can be extinguished once the set of parameter settings are stored in the NV preset memory 206. The set of parameter settings and audio effects on/off states stored in the NV preset memory 206 at the default memory address are referred to herein collectively as a “parameter settings configuration” or, more simply, a “scene”.

As described herein with reference to FIG. 4d, the personal computer 404 is operative to send/receive serial data to/from the central management hub 200 over the bidirectional data path 222. In this example, the personal computer 404 can be connected to the USB port 216 of the central management hub 200 for modifying, via a graphical user interface (GUI), the parameter settings configuration(s) and audio effects on/off state(s) stored in the NV preset memory 206. It is noted that such modification of the parameter settings configuration(s) and/or audio effects on/off state(s) can alternatively be performed over a Bluetooth connection, a WiFi connection, or any other suitable connection between the personal computer 404 and the central management hub 200. In addition, the modified parameter settings configuration(s) and/or audio effects on/off state(s) can be restored and auditioned at the respective effects pedals 406a, 406b, 406c prior to storing the modified configuration(s) and/or states(s) in the NV preset memory 206.

FIG. 4e depicts an illustrative embodiment of a GUI 470 that can be provided on a display of the personal computer 404 connected to the central management hub 200. As shown in FIG. 4e, the GUI 470 includes a first window 472 listing the effects pedals 406a, 406b, 406c connected to the central management hub 200 according to their respective device IDs (e.g., device ID “A1” for the effects pedal 406a, device ID “B1” for the effects pedal 406b, and device ID “C1” for the effects pedal 406c). The GUI 470 further includes a second window 474 that has graphical representations of the respective effects pedals 406a (“Effects Pedal A1”), 406b (“Effects Pedal B1”), 406c (“Effects Pedal C1”), as well as graphical representations of a number of pushbuttons that the user can “click on” (e.g., using a keyboard, a mouse, or any other suitable computer input device) to make a new scene (“Make Scene”), to save a scene (“Save Scene”), to import a scene (“Import Scene”), to export a scene (“Export Scene”), to modify an effects pedal's software parameter settings (“Modify Pedal Settings”), to add a new effects pedal in the audio signal path (“Add New Pedal”), and to delete an effects pedal from the audio signal path (“Delete Pedal”). As described herein, the bypass command can be used to place one or more of the effects pedals 406a, 406b, 406c connected to the central management hub 200 in a bypass (effectively “disconnected”) state. The second window 474 further has indications of whether a respective one of the effects pedals is engaged or bypassed in the audio signal path. In this example, all of the effects pedals 406a, 406b, 406c are engaged in the audio signal path, as indicated, for example, by the bold font used to display the term “Engaged”, and the regular font used to display the term “Bypassed”, within the second window 474.

For example, the user can click on one or more of the graphical representations of the respective effects pedals 406a, 406b, 406c in the GUI 470 to select one of the effects pedals 406a, 406b, or 406c, and then click on the graphical representation of the Modify Pedal Settings pushbutton to modify the software parameter settings and/or audio effects on/off state stored in the NV preset memory 206 for the selected effects pedal (as indicated, for example, by the box surrounding the graphical representation of the effects pedal 406a (Effects Pedal A1); see FIG. 4e). In one embodiment, after having clicked on the Modify Pedal Settings pushbutton, an editable listing of the current parameter settings and audio effects on/off state for the selected effects pedal (including an indication of whether that effects pedal is “Engaged” or “Bypassed” in the audio signal path) can be displayed on the personal computer 404 and modified, as desired, by the user. The user modifications of the parameter settings and audio effects on/off state for the selected effects pedal are then stored in the NV preset memory 206 for subsequent retrieval.

In response to the user's momentary actuation of the RECALL/COPY pushbutton 207, the central management hub 200 can recall or access the parameter settings configuration (i.e., the scene) stored in the NV preset memory 206 at the default memory address, and send a set parameters command to each of the effects pedals 406a, 406b, 406c via the cables 412a, 412b, 412c, respectively, thereby restoring the (possibly modified) set of parameter settings corresponding to that parameter settings configuration at the respective effects pedals 406a, 406b, 406c. As with the user's actuation of the SCAN/SAVE pushbutton 205, a visual indication of the user's momentary actuation of the RECALL/COPY pushbutton 207 can be provided by a corresponding momentary illumination of the LED 236.

As described herein with reference to FIG. 4c, the MIDI controller 402 is operative to provide MIDI input data (e.g., one or more MIDI commands) to the central management hub 200 over the data input path 224. In this example, the MIDI controller 402 can be used to specify at least one memory address at which to store, in the NV preset memory 206, at least one parameter settings configuration for the respective effects pedals 406a, 406b, 406c by sending at least one MIDI program change command to the central management hub 200 via the MIDI input port 212.

Having received a first specified memory address included in a first MIDI program change command, the central management hub 200 can store, in response to the user's extended actuation of the SCAN/SAVE pushbutton 205, the parameter settings configuration for the respective effects pedals 406a, 406b, 406c in the NV preset memory 206 at the first specified memory address. Further, in response to the user's momentary actuation of the RECALL/COPY pushbutton 207, the central management hub 200 can recall or access the parameter settings configuration stored in the NV preset memory 206 at the first specified memory address, and send a set parameters command to each of the effects pedals 406a, 406b, 406c to restore the set of parameter settings corresponding to that parameter settings configuration at the respective effects pedals 406a, 406b, 406c.

Moreover, having received a second specified memory address included in a second MIDI program change command, the central management hub 200 can optionally copy, in response to the user's extended actuation of the RECALL/COPY pushbutton 207, the parameter settings configuration stored at the first specified memory address location within the NV preset memory 206 to the second specified memory address location within the NV preset memory 206. As with the user's actuation of the SCAN/SAVE pushbutton 205, a visual indication of the user's extended actuation of the RECALL/COPY pushbutton 207 can be provided by a corresponding extended illumination of the LED 236, which can be extinguished once the set of parameter settings are copied in the NV preset memory 206.

In this example, the functions of (1) receiving a specified memory address at the central management hub 200 from the MIDI controller 402, and (2) storing a parameter settings configuration in the NV preset memory 206 at the specified memory address, can be repeated multiple times for storing a plurality of parameter settings configurations in the NV preset memory 206 at a plurality of specified memory addresses, respectively. Further, in response to one or more simple user inputs (e.g., the user's actuation of a pushbutton or footswitch associated with the MIDI controller 402), the MIDI controller 402 can send one or more MIDI program change commands, each including an indication of one of the plurality of specified memory addresses, to the central management hub 200, thereby causing the central management hub 200 (1) to recall or access the parameter settings configuration stored in the NV preset memory 206 at that specified memory address, and (2) to send a set parameters command to each of the effects pedals 406a, 406b, 406c via the cables 412a, 412b, 412c, respectively, to restore the set of parameter settings corresponding to that parameter settings configuration at the respective effects pedals 406a, 406b, 406c. In this way, a number of different parameter settings configurations (e.g., 128 or any other suitable number) can be recalled/accessed from the NV preset memory 206, and corresponding sets of parameter settings can be restored at the respective effects pedals 406a, 406b, 406c, in response to the user's actuation of the pushbutton or footswitch associated with the MIDI controller 402.

Having described the above illustrative embodiments, other modifications to and variations of the disclosed systems can be made. For example, it was described herein that the MIDI controller 402 can send one or more MIDI program change commands to the central management hub 200 to cause a number of different parameter settings configurations to be recalled/accessed from the NV preset memory 206, and corresponding sets of parameter settings to be restored at the respective effects pedals 406a, 406b, 406c, in response to the user's actuation of a pushbutton or footswitch associated with the MIDI controller 402. In an alternative embodiment, such functionality of the MIDI controller 402 and associated user interface controls, displays, and/or LEDs can be incorporated within the central management hub 200 itself, obviating the need to provide an external MIDI controller.

It was further described herein that the central management hub 200 can communicate with the respective effects pedals 406a, 406b, 406c over the interconnected ports using a predetermined communication protocol. In an alternative embodiment, the central management hub 200 can be used to provide limited management of and/or control over an audio effects processor (e.g., an effects pedal) that is not compatible with the predetermined communication protocol.

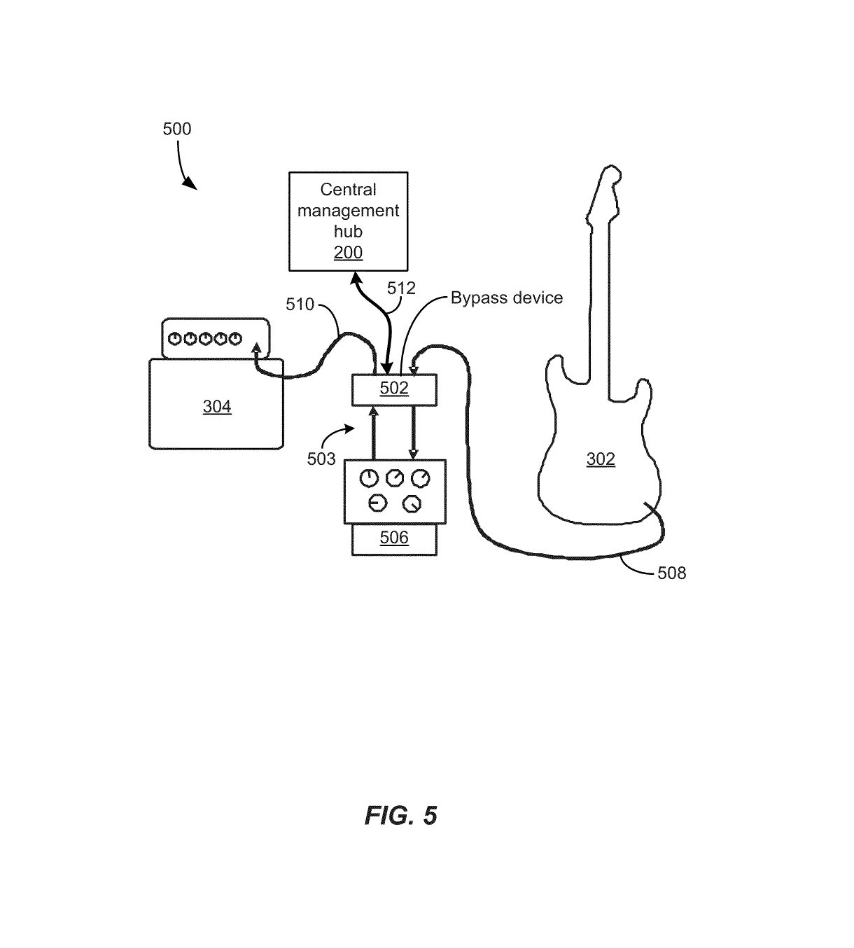

FIG. 5 depicts an exemplary system 500 that includes such an incompatible effects pedal 506 connected to a bypass device 502, which, in turn, is connected between the electric guitar 302 and the sound amplifier 304 of FIG. 3. As shown in FIG. 5, the bypass device 502 can receive, over a cable 512, commands defined by the predetermined communication protocol from the central management hub 200, as well as send, as appropriate over the cable 512, responses to the commands. For example, such commands can include a bypass command for effectively disconnecting the effects pedal 506 from the audio signal path.

As further shown in FIG. 5, the bypass device 502 can receive, over a cable 508, an audio input signal produced by the electric guitar 302. In the event the effects pedal 506 is currently engaged in the audio signal path by the bypass device 502, the effects pedal 506 can receive the audio input signal from the bypass device 502, perform audio effects processing on the audio input signal to produce a desired effect (e.g., a chorus effect, a flanging effect, a phaser effect, a ring modulation effect, a tremolo effect, a vibrato effect, etc.), generate a processed audio output signal, and provide the audio output signal to the bypass device 502, which, in turn, can provide the audio output signal, over a cable 510, to the sound amplifier 304 for amplification.

In the event the effects pedal 506 has been effectively disconnected from the audio signal path by the bypass device 502, the bypass device 502 can receive the audio input signal from the electric guitar 302 over the cable 508, and directly route the unprocessed audio input signal over the cable 510 to the sound amplifier 304 for amplification. For example, the effects pedal 506 can be connected to or disconnected from the audio signal path in response to the user's actuation of a pushbutton associated with the bypass device 502. Indications of whether the effects pedal 506 is connected to or disconnected from the audio signal path by the bypass device 502 can also be saved/recalled as part of one or more parameter settings configurations (scenes) stored in the NV preset memory 206 of the central management hub 200.

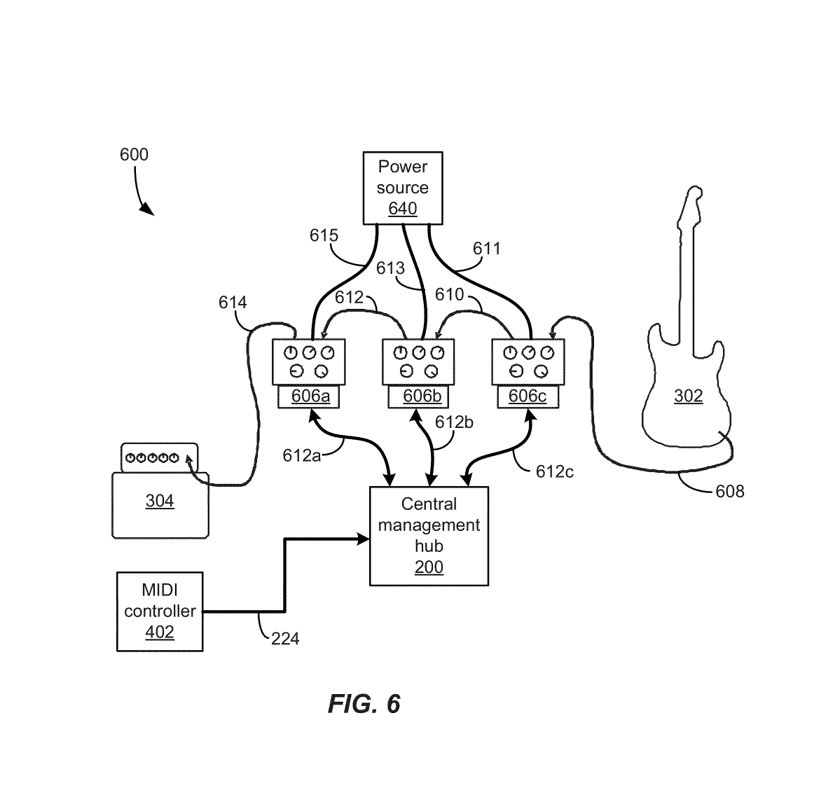

FIG. 6 depicts an exemplary system 600 that includes a number of parallel connections 612a, 612b, 612c between the central management hub 200 of FIG. 2a and a plurality of audio effects processors (e.g., effects pedals) 606a, 606b, 606c, respectively, which, in turn, are connected between the electric guitar 302 and the sound amplifier 304 of FIG. 3. As shown in FIG. 6, the plurality of effects pedals 606a, 606b, 606c are serially-connected in an audio signal path by a plurality of cables 608, 610, 612, 614, and are further connected to an external power source 640 by a plurality of power cords 615, 613, 611, respectively. As further shown in FIG. 6, the MIDI controller 402 of FIG. 4c is connected by a cable (not numbered) to the central management hub of FIG. 2a over the data input path 224.

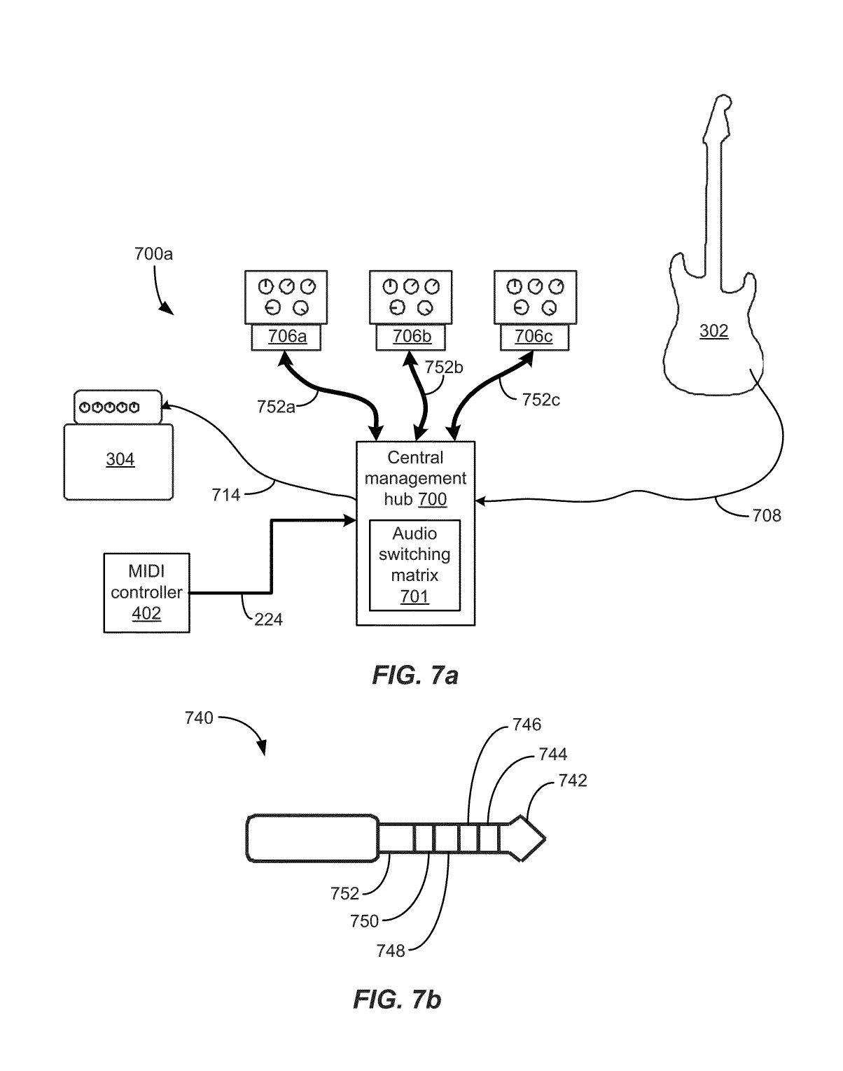

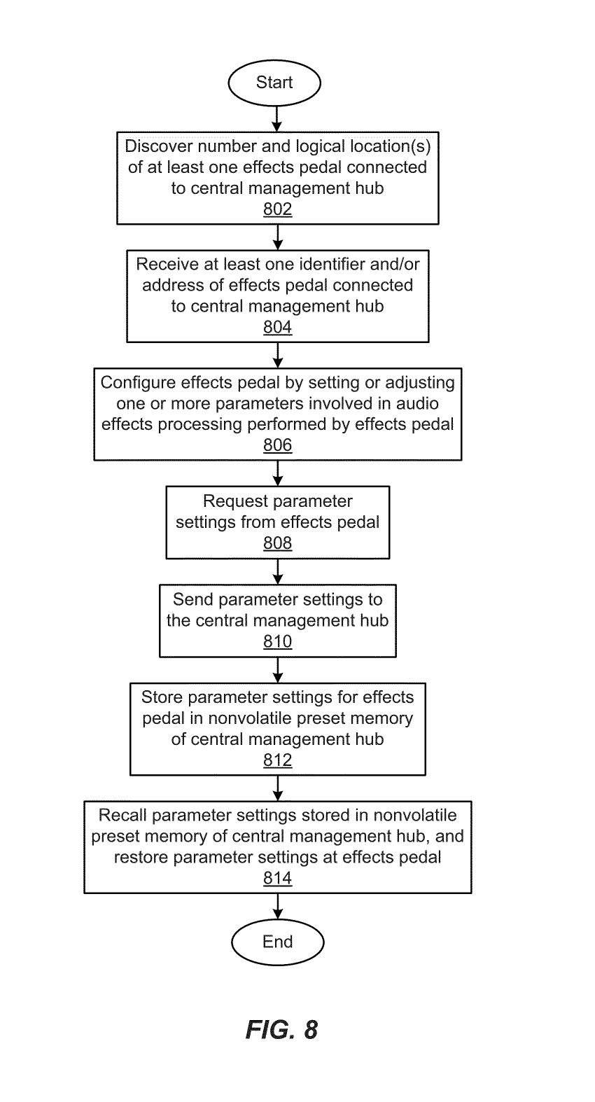

FIG. 7a depicts an exemplary system 700a that includes an alternative embodiment 700 of the central management hub 200, which reduces the number of cords and/or cables required for providing power, communications, and/or audio signals to/from a plurality of audio effects processors (e.g., effects pedals) 706a, 706b, 706c. As shown in FIG. 7a, the central management hub 700 is configured to receive an audio input signal over a cable 708 from the electric guitar 302 of FIG. 3, and to provide an audio output signal over a cable 714 to the sound amplifier 304 of FIG. 3. The central management hub 700 is parallel-connected to the plurality of effects pedals 706a, 706b, 706c by a plurality of cables 752a, 752b, 752c, respectively. The central management hub 700 is further connected to the MIDI controller 402 of FIG. 4c over the data input path 224 by a cable (not numbered).

In the system 700a of FIG. 7a, the plurality of power cords 615, 613, 611 (see FIG. 6) providing power from the external power source 640 to the plurality of effects pedals 606a, 606b, 606c, respectively, as well as the cables 612, 610 (see also FIG. 6) for serially-connecting the respective effects pedals 606a, 606b, 606c in the audio signal path, can be eliminated by providing the required power, serial data, and audio signals to/from the effects pedals 706a, 706b, 706c via the cables 752a, 752b, 752c (see FIG. 7a), respectively. Moreover, by configuring the central management hub 700 to include an audio switching matrix 701, the central management hub 700 can use the audio switching matrix 701 to effectively change the order of the effects pedals 706a, 706b, 706c in the audio effects processing sequence, without requiring the user to physically re-wire the system 700a.

FIG. 7b depicts an exemplary multifunction port connector 740 configured for use with the cables 752a, 752b, 752c for sending/receiving power, serial data, and audio signals between the central mangement hub 700 and the plurality of effects pedals 706a, 706b, 706c. As shown in FIG. 7b, in one embodiment, the multifunction port connector 740 can be configured as a 6-conductor, ⅛ inch TRRRRS (tip-ring-ring-ring-ring-sleeve) plug, including a tip 742, a first ring 744, a second ring 746, a third ring 748, a fourth ring 750, and a sleeve 752. In this embodiment of the multifunction port connector 740, the tip 742 is operative to carry power, the first ring 744 is operative to handle serial receive data, the second ring 746 is operative to handle serial send data, the third ring 748 is operative to handle audio receive signals, the fourth ring 750 is operative to handle audio send signals, and the sleeve 752 is operative to provide a ground reference.

It was further described herein that the central management hub 200 can send/receive serial data over the bidirectional data paths 226.1, 226.2, . . . , 226.n using the UART 202b included in the microcontroller 202. In an alternative embodiment, one or more of the bidirectional multifunction ports 1, 2, . . . , n can be configured as USB ports (or any other suitable ports conforming to any other suitable serial communication format), enabling such bidirectional communication of serial data between the central management hub 200 and one or more effects pedals to occur over one or more universal serial buses (USBs) (or any other suitable buses conforming to any other suitable serial communication format).

A method of operating the central management hub 200 for networking and managing a plurality of effects pedals for musical instruments and vocal microphones is described below with reference to FIGS. 2a and 8. As depicted in block 802 (see FIG. 8), the central management hub 200 (see FIG. 2a) discovers the number and logical location(s) of at least one effects pedal connected to it by sending a ping command over each of its bidirectional multifunction ports 1, 2, . . . , n. In the event one of the bidirectional multifunction ports 1, 2, . . . , n of the central management hub 200 is connected to a corresponding bidirectional multifunction port of an effects pedal, the central management hub 200 receives, as depicted in block 804, a ping response from the effects pedal over the interconnected ports, such a ping response including at least an identifier and/or an address of the effects pedal. Once the central management hub 200 has discovered all of the effects pedal(s) connected to it, a user (e.g., a musician or vocalist) configures the connected effects pedal(s) by setting or adjusting one or more parameters involved in the audio effects processing performed by the effects pedal(s), as depicted in block 806. For example, such parameter settings/adjustments can be made by the user's manipulation of one or more knobs, pushbuttons, switches, sliders, and/or other user interfaces associated with the effects pedal(s). After the effects pedal(s) connected to the central management hub 200 has/have been configured by the user, the central management hub 200 requests the parameter settings by sending a get parameters command to the effects pedal(s) over the interconnected ports, as depicted in block 808. In response to the get parameters command, the effects pedal(s) sends its current parameter settings to the central management hub 200 over the interconnected ports, as depicted in block 810. As depicted in block 812, the central management port 200 stores the parameter settings for the effects pedal(s) in its NV preset memory 206 at a default memory address. At a later time, the central management hub 200 recalls or otherwise accesses the parameter settings stored in the NV preset memory 206 at the default memory address, and restores the parameter settings at the effects pedal(s) by sending a set parameters command to the effects pedal(s) over the interconnected ports, as depicted in block 814.

It will be appreciated by those of ordinary skill in the art that further modifications to and variations of the above-described systems and methods may be made without departing from the inventive concepts disclosed herein. Accordingly, the disclosed invention should not be viewed as limited except as by the scope and spirit of the appended claims.

What is claimed is:

1. A system for networking and managing one or more audio effects processors for musical instruments and vocal microphones, comprising:
at least one processor;
a plurality of memories connected to the at least one processor, the plurality of memories including a program memory and a nonvolatile memory; and
a plurality of bidirectional ports communicably connected to the at least one processor,
wherein the at least one processor is operative to execute at least one computer program out of the program memory:
to send a first command over at least one of the plurality of bidirectional ports to at least one of the one or more audio effects processors;
to receive, over the at least one bidirectional port in response to the sending of the first command, one or more parameter settings from the at least one audio effects processor, the one or more parameter settings determining audio effects processing by the at least one audio effects processor;
to store the one or more parameter settings in the nonvolatile memory; and
to access, in response to at least one user input, the one or more parameter settings from the nonvolatile memory for subsequent application to the at least one audio effects processor.

2. The system of claim 1 further comprising:
a serial bus port, and
wherein the at least one processor is further operative to execute the at least one computer program out of the program memory to send the one or more parameter settings over the serial bus port to a computer or computerized device.

3. The system of claim 2 wherein the computer or computerized device is operative to provide a graphical user interface (GUI) for modifying the one or more parameter settings, and wherein the at least one processor is further operative to execute the at least one computer program out of the program memory:
to receive, over the serial bus port, the modified parameter settings from the computer or computerized device; and
to store the modified parameter settings in the nonvolatile memory.

4. The system of claim 3 wherein the at least one processor is further operative to execute the at least one computer program out of the program memory to access, in response to the at least one user input, the modified parameter settings from the nonvolatile memory for subsequent application to the at least one audio effects processor.

5. The system of claim 1 further comprising:
a musical instrument digital interface (MIDI) input port, and
wherein the at least one processor is further operative to execute the at least one computer program out of the program memory to receive the at least one user input over the MIDI input port from a MIDI controller.

6. The system of claim 1 wherein the at least one audio effects processor includes a bidirectional port communicably connectable to the at least one bidirectional port of the system, and wherein the at least one processor is further operative to execute the at least one computer program out of the program memory to apply the one or more parameter settings over the communicably connectable bidirectional ports to the at least one audio effects processor.

7. The system of claim 1 wherein the at least one processor is further operative to execute the at least one computer program out of the program memory:
to receive, over the at least one bidirectional port in response to the sending of the first command, a plurality of sets of parameter settings from the respective audio effects processors, each set of parameter settings determining specified audio effects processing by the respective audio effects processors; and
to store the plurality of sets of parameter settings at a plurality of specified memory addresses, respectively, in the nonvolatile memory.

8. The system of claim 7 wherein the at least one processor is further operative to execute the at least one computer program out of the program memory to access, in response to a plurality of successive user inputs, the plurality of sets of parameter settings from the nonvolatile memory for subsequent application to the respective audio effects processors.

9. The system of claim 8 further comprising:
a musical instrument digital interface (MIDI) input port, and
wherein the at least one processor is further operative to execute the at least one computer program out of the program memory to receive the plurality of successive user inputs over the MIDI input port from a MIDI controller.

10. The system of claim 1 wherein the one or more audio effects processors are disposed in an audio signal path, wherein the one or more audio effects processors include at least one audio effects processor incompatible with the system, wherein the system further comprises:
a bypass device communicably connectable to the at least one incompatible audio effects processor, and
wherein the at least one processor is further operative to execute the at least one computer program out of the program memory to send, to the bypass device, a second command over at least one of the plurality of bidirectional ports for selectively performing one of engaging and bypassing the at least one incompatible audio effects processor in the audio signal path.

11. The system of claim 1 wherein the one or more audio effects processors are implemented as one or more effects pedals.

12. The system of claim 1 further comprising:
a serial bus port, and
a computer or computerized device operative to receive the one or more parameter settings over the serial bus port from the at least one processor.

13. The system of claim 12 wherein the computer or computerized device is operative to provide a graphical user interface (GUI) for modifying the one or more parameter settings.

14. The system of claim 13 wherein the computer or computerized device is further operative to send, over the serial bus port, the modified parameter settings to the at least one processor for subsequent storage in the nonvolatile memory.

15. The system of claim 1 further comprising:
a universal asynchronous receiver-transmitter (UART), and
wherein the at least one processor is further operative to execute the at least one computer program out of the program memory to send and receive serial data, using the UART, to and from at least one of the one or more audio effects processors over at least one of the plurality of bidirectional ports.

16. The system of claim 1 wherein the plurality of bidirectional ports are each configured as a universal serial bus (USB) port.

17. A method of networking and managing one or more audio effects processors for musical instruments and vocal microphones, comprising:
sending, by at least one processor, a first command over at least one of a plurality of bidirectional ports to at least one of the one or more audio effects processors;
receiving, at the at least one processor over the at least one bidirectional port in response to the sending of the first command, one or more parameter settings from the at least one audio effects processor, the one or more parameter settings determining audio effects processing by the at least one audio effects processor;
storing, by the at least one processor, the one or more parameter settings in a nonvolatile memory; and
accessing, by the at least one processor in response to at least one user input, the one or more parameter settings from the nonvolatile memory for subsequent application to the at least one audio effects processor.

18. The method of claim 17 further comprising:
sending, by the at least one processor, the one or more parameter settings over a serial bus port to a computer or computerized device.

19. The method of claim 18 wherein the computer or computerized device is operative to provide a graphical user interface (GUI) for modifying the one or more parameter settings, and wherein the method further comprises:
receiving, at the at least one processor over the serial bus port, the modified parameter settings from the computer or computerized device; and
storing, by the at least one processor, the modified parameter settings in the nonvolatile memory.

20. The method of claim 19 further comprising:
accessing, by the at least one processor in response to the at least one user input, the modified parameter settings from the nonvolatile memory for subsequent application to the at least one audio effects processor.

21. The method of claim 17 further comprising:
receiving, at the at least one processor over a musical instrument digital interface (MIDI) input port, the at least one user input from a MIDI controller.

22. The system of claim 17 further comprising:
applying the one or more parameter settings over the at least one bidirectional port to the at least one audio effects processor.
